(19) United States
(12) Patent Application Publication
(10) Pub. No.: US 2022/0214860 A1
(43) Pub. Date: Jul. 7, 2022

(54) ANIMAL INTERACTION DEVICE, SYSTEM, AND METHOD

(71) Applicant: Karen Davis Jenkins, Chapel Hill, NC (US)

(72) Inventor: Karen Davis Jenkins, Chapel Hill, NC (US)

(21) Appl. No.: 17/568,846

(22) Filed: Jan. 5, 2022

Related U.S. Application Data
(60) Provisional application No. 63/134,512, filed on Jan. 6, 2021.

(51) Int. Cl. G06F 3/16; A01K 29/00; G08C 17/02

(52) U.S. Cl. CPC G06F 3/167; G08C 17/02; A01K 29/00

(57) ABSTRACT

The invention provides a device, system, and method for facilitating human-animal interactions. Specifically, the invention comprises a mat or flexible housing made up of a plurality of customizable touch input pads, each generating a customizable audio output. Each touch input pad may be customized by a user to create a desired sight, smell, or other sensory experience for an animal. In addition, each touch input pad may be associated with a customizable audio file which is outputted upon receiving a touch input command. The device is both water and heat resistant and is made of a flexible material which allows the device to be easily folded or rolled for storage and/or transport.

### CROSS-REFERENCE TO RELATED APPLICATION

This application is a non-provisional application of and claims priority and benefit to U.S. Provisional Patent Application No. 63/134,512, filed Jan. 6, 2021 and of the same title; the contents of which are incorporated herein by reference.

### FIELD OF THE INVENTION

In general, the present invention is directed a device, system, and method for facilitating human-animal interactions.

### BACKGROUND

Many devices and methods exist for training animals to obey commands and to respond to an owner's needs and wants. Very few devices, however, enable an animal to communicate its needs and wants back to an owner. Even in situations where an owner is attuned to an animal's behavior, it is very likely that at some point the animal will be in the care of a non-owner, who is not familiar with that animal's behavior. Because of this, there is a need for a device which allows an animal to express a variety of needs in a manner which is easily understood by multiple humans, including non-owners.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides a device, system, and method for facilitating human-animal interactions. Specifically, in some embodiments, the invention comprises a flexible housing which contains a control unit, an audio output, and a plurality of input pads. The invention may store an audio file associated with each input pad, and each input pad may include an input unit which, when activated, causes the associated audio file to be played. In addition, in some embodiments, the input pads may include sensory units which are able to be filled with sensory items, images, or other indicia that indicate which audio file is associated with a particular input pad. Further, in some embodiment, the audio file may be replaced by a video file or image file that may be displayed on an associated display, where the video or image file is associated with one or more input pads for display when the input pad(s) is depressed. Further, in some embodiments, both audio and video or image files may be associated with an input pad so that both the audio file is play and video or image file is displayed when the input pad is depressed.

For example, in one embodiment, a system is provided for facilitating animal-human interactions. The system comprises a flexible housing, a control unit, a memory device configured to store at least one audio file, an audio output device, a communication device, and at least one input pad. The input pad comprises an input unit, where the input unit is in operative communication with the communication device and a sensory unit, where the sensory unit is configured to hold at least one sensory object. The input pad is associated with the at least one audio file stored in said memory device. The input unit is configured, such that when interacted with by an animal or human, the input unit transmits a detection signal to the control unit via the communication device. Upon receiving a detection signal from the input unit, the control unit retrieves the audio file from memory associated with the at least one input pad and controls the audio output device to output audio from the audio file.

Some embodiments of the system may include a display connected to the control unit, wherein the memory device comprises at least one video or image file associated with the at least one input pad, wherein when the control unit receives a detection signal from the input pad, the control unit retrieves the audio or image file and controls the display to output the video or image from the audio or image file.

In some embodiments, the at least one input pad further comprises a wireless transmitter for transmitting a detection signal wirelessly to the control unit via a wireless receiver in the communication device when the at least one input pad is interacted with by an animal or human.

In some embodiments, the at least one input pad comprises a pad housing, a padding layer, and a communication layer, wherein the sensory unit is connected to the pad housing.

In some embodiments, the sensory unit comprises a pocket for receiving one or more sensory items.

In some embodiments, the system comprises a plurality of input pads, wherein at least one of the input pads comprises an associated sensory unit with indicia printed thereon and wherein at least one of the input pads comprises an associated sensory unit comprising a pocket for receiving a sensor item.

In at least one embodiment, the system comprises a plurality of input pads, wherein at least one of the plurality of input pads is connected via wires to the communication device for communicating therewith, and wherein at least one of the plurality of input pads is configured for wireless connection with the communication device for communicating wirelessly therewith.

In at least one embodiment, the system comprises at least one wired input pad, wherein the wired input pad comprises a first input unit, wherein the first input unit is in operative communication with the communication device and a first sensory unit, wherein the sensory unit is configured to hold at least one sensory object. The at least one wired input pad is associated with at least one first audio file stored in the memory device. The first input unit is configured, such that when interacted with by an animal or human, the first input unit transmits a first detection signal to the control unit via the communication device. The system further includes at least one wireless input pad, wherein the wireless input pad comprises a second input unit, a wireless transmitter configured for wireless communication with the communication device, and a second sensory unit, wherein the sensory unit is configured to hold at least one sensory object. The at least one wireless input pad is associated with at least one second audio file stored in the memory device. The second input unit is configured, such that when interacted with by an animal or human, the second input unit transmits wirelessly a second detection signal to the control unit via the communication device. The control unit, upon receiving either a first detection signal from the wired input unit or a second detection signal from the wireless input device, retrieves the respective first or second audio file from memory associated and controls the audio output device to output audio from the respective audio file.

### BRIEF DESCRIPTION OF THE DRAWINGS

FIG. 1 is a block diagram for the animal interaction device, in accordance with one or more embodiments of the present invention.

FIG. 2 is a block diagram depicting a cross-sectional view of an input pad associated with the animal interaction device, in accordance with one or more embodiments of the present invention.

FIG. 3A is a block diagram depicting a control unit and an input pad associated with the animal interaction device, in accordance with one or more embodiments of the present invention.

FIG. 3B is a block diagram depicting a control unit and an input pad associated with the animal interaction device, in accordance with one or more embodiments of the present invention.

FIG. 4 depicts a high-level process flow for a method of utilizing the animal interaction device, in accordance with one or more embodiments of the present invention.

FIG. 5 is an illustration of a series of sensory units for the animal interaction device, in accordance with one or more embodiments of the present invention.

FIG. 6 is a block diagram depicting a control unit and an input pad associated with the animal interaction device, in accordance with one or more embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, the present invention enhances human-animal communication by allowing an animal to make a request from a human user via a selection from a plurality of input pads which have been customized to represent a plurality of sensory experiences. As an example, in present households, if an animal needs water, it may communicate that need in any variety of ways, including barking, standing near an empty water bowl, following an owner, or the like. While an owner who is familiar with the animal's behavior may readily understand the animal's needs, this communication may go unnoticed or unrecognized by another human, such as a pet-sitter or other household member. Furthermore, a communication method such as loud barking may be undesirable to an owner living in an apartment or other situation in which the barking may disturb other humans.

The invention described herein eliminates these communication issues by providing a means of translation between a sensory experience, i.e. sight or smell and an audio or voice message, and vice versa. In some embodiments, the invention may be used for an animal to express basic needs such as a food and water. Additionally or alternatively, the invention may be used for more advanced training such as commanding the animal to stay in place or to go outside. The benefits of this invention include not only enhanced communication channels between an animal and its owner, but also allows basic communication between an animal and a non-owner which has previously been non-existent.

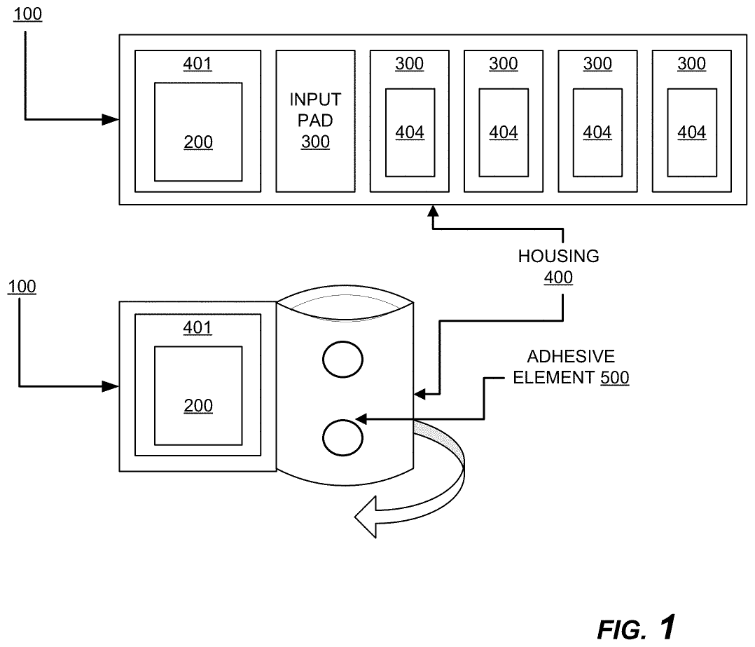

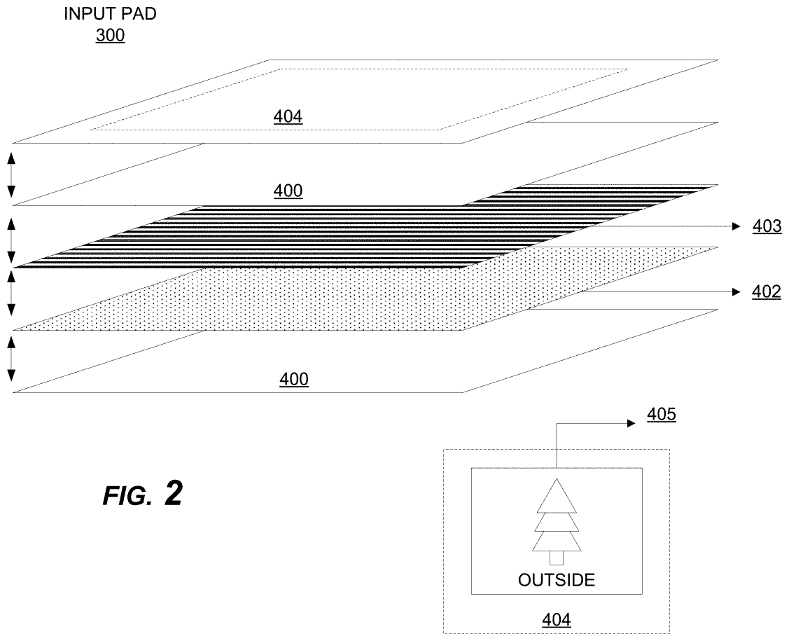

FIG. 1 shows a block diagram of the animal interaction device 100, in accordance with one or more embodiments. The animal interaction device 100 may comprise a control unit 200, a plurality of input pads 300, and a housing 400. The housing 400 may be constructed of a flexible material such as silicon, vinyl, or the like and may allow the animal interaction device 100 to be folded or rolled for storage or transport. The housing 400 may also be constructed of waterproof or water-resistant material which provides protection to the control unit 200 and input pads 300. The input pads 300 may be arranged in a single row which is a capable of being folded or rolled as depicted in FIG. 1. In some embodiments, the input pads may be detachable, allowing any one or more of the plurality of input pads to be temporarily removed from the device 100 or rearranged to thereby customize the device to the user and/or the animal. Each of the plurality of input pads 300 may comprise a sensory unit 404 on its surface that allows for further customization, which are discussed in further detail in FIG. 2.

The control unit 200 may be located on either side of the row of input pads 300 and may encased in an additional control unit housing 401. The control unit housing 401 may be made of a heat-resistant material and/or a more rigid material than the housing 400 in order to provide additional protection to the control unit 200.

The animal interaction device 100 according to at least one embodiment may also include one or more adhesive elements 500 which prevent the device from slipping when placed on a flat surface. The adhesive elements 500 may comprise any material which provides temporary adhesion to a smooth surface, such as removable suction cups or textured silicon grips.

The animal interaction device 100 may further comprise additional elements not depicted, including but not limited to: printed user instructions or a user guide, batteries and/or an AC power adapter, and a storage and/or transport mechanism such as a bag, strap, handle, or the like.

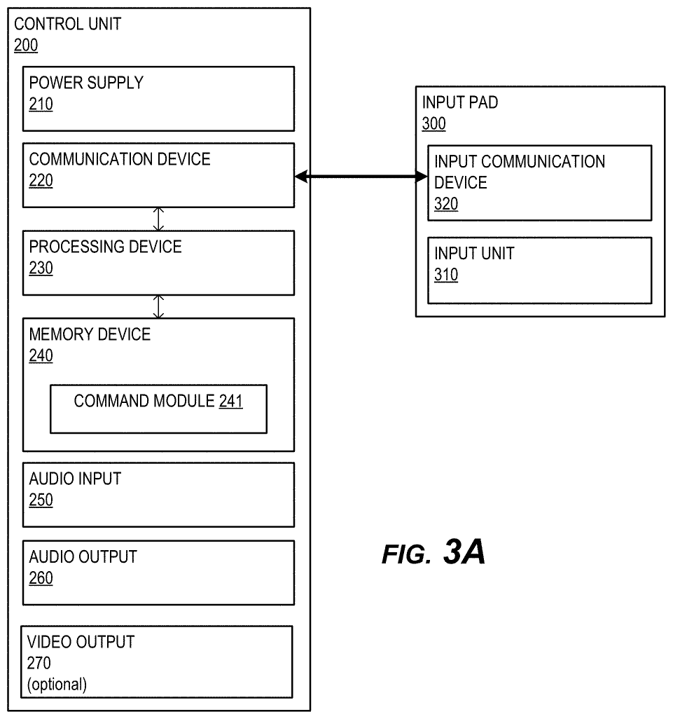

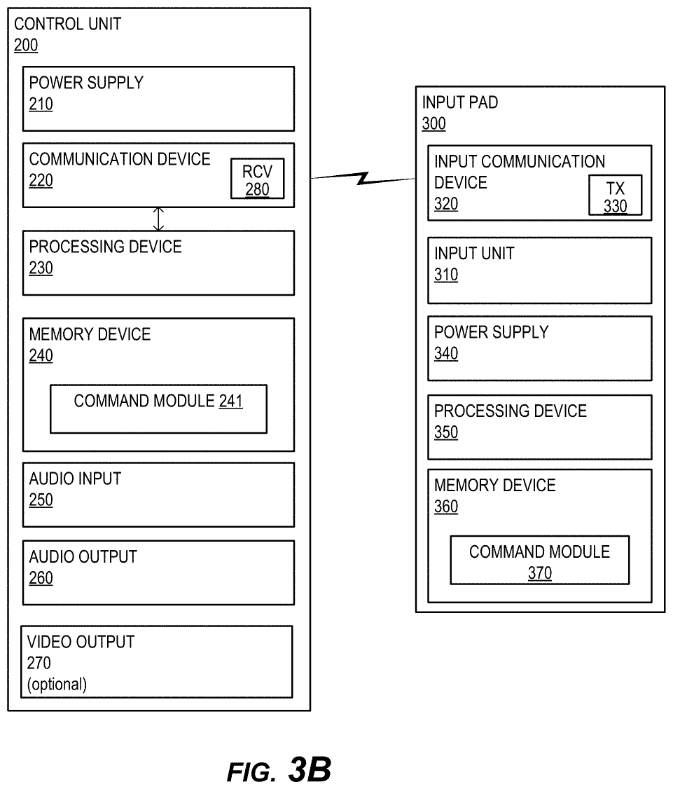

FIG. 2 illustrates a cross-sectional view of one of a plurality of input pads 300. Each input pad may comprise a plurality of layers, including a housing 400, padding layer 402, communication layer 403, and a sensory unit 404. As previously discussed, the housing 400 may be constructed of a flexible and/or waterproof material and may comprise a top and bottom layer which provide protection and/or water resistance to the other layers contained within. In some embodiments, the input pad comprises a communication layer 403 which further comprises the necessary circuitry to accept a touch or pressure input and transmit/receive information about a touch input to the control unit 200, as is further discussed in FIGS. 3A & 3B. In some embodiments, the input pad also comprises a padding layer 402 which may be constructed of a foam or other such material which provides additional protection as well as insulation to the circuitry contained in the communication layer 403.

Each input pad may comprise a sensory unit 404 on its outer surface which may comprise a pocket or pouch. In some embodiments, the housing 400 may be transparent such that the sensory unit is visible underneath the housing, while in other embodiments, the sensory unit may comprise a transparent pocket or pouch which is located on the outer surface of the housing 400. A user may fill the sensory unit with any variety of sensory items that an animal may recognize such as grass, food items, fabric from a toy or bed, treats, pictures, images, drawings, and/or the like. Additionally or alternatively, the sensory unit may comprise a removeable card 405 which may include a picture, color, written word, or other indicia which indicates an object or action. Further, in other embodiments, the sensory units may be customized using different textures to differentiate the different input pads. For example, the sensory unit for the input pad for “Go Outside” could be textured to feel like grass, the sensory unit for the input pad for “Take a Nap” could have a plush feel, the sensory unit for the input pad for “Water” could have a wave pattern, and so on, such that the animal can distinguish the input pads based on sensory feel of the texture of the sensory units for each input pad. The sensory unit thus allows the user to customize the animal interaction device to the particular needs of the animal or the owner. The user can customize each input pad with specific indicia and sensory items. In this, as discussed later, the recorded commands can be customized to correspond to the user's customization of the input pads.

An added benefit it that interchangeability of what is placed in each sensory unit, the user can customize the order of sensor unit placements so as to accommodate teaching needs for the animal. For example, the animal may be or become confused if two like sensory items are placed adjacent or near each other. This can be addressed by placing such confusing sensory items at farther distance apart from each other on the device to lessen or avoid confusion by the animal.

FIG. 3A shows a block diagram illustrating the control unit 200 and input pad 300, in accordance with some embodiments. The control unit 200 may comprise a power supply 210, a communication device 220, a processing device 230, a memory device 240 having a command module 241, an audio input 250, and an audio output 260. The power supply 210 may comprise an alkaline battery, a rechargeable lithium battery, an AC power connection, or the like. In some embodiments, the power supply 210 further comprises an on/off switch. As shown, the processing device 230 is operatively connected to and is configured to control and cause the communication device 220 and the memory device 240 to perform one or more functions. The processing device 230 may generally refer to a device or combination of devices having circuitry used for implementing the communication and/or logic functions of the command module 241, and may be configured to use the communication device 220 to transmit and/or receive data and/or commands to and/or from the one or more of the plurality of input pads 300. The communication device 220 may be configured to allow the control unit 200 to transmit and receive data from the plurality of input pads 300 via a wired connection wherein the connecting wires are encased within the communication layer 403 of the housing 400.

The memory device may include a command module 241 which allows an audio file associated with a particular input pad 300 to be recorded and stored. The command module may be pre-programmed by the device manufacturer to include an audio file associated with one or more of the input pads 300. In other embodiments, audio files may be recorded during a device set up process. Audio files may be recorded via the audio input 250, which may comprise a microphone or other acoustic sensor. Audio files may be outputted through the audio output 260, which may comprise a speaker or the like and may further comprise a volume control input. In some embodiments, the audio input 250 and the audio output 260 may be integrated in a single microphone/speaker device. In some embodiments, the device may comprise a single audio input 250 and single audio output 260 located on the control unit 200, or the device may comprise a plurality of audio inputs 250 and audio outputs 260, wherein each input pad 300 comprises an individual audio input and output device located within the communication layer 403 of the input pad 300.

Each input pad 300 may comprise an input communication device 320 and an input unit 310 located on the communication layer 403 of the input pad. The input communication device 320 may be in operative communication with the communication device 220 via a wired connection which allows the input communication device 220 to transmit/receive data from the control unit 200. The input unit 310 may comprise a button, trigger, switch, or the like which is able to be activated by an animal or human by pressing or tapping. The input unit 310 and input communication device 320 may be operatively coupled such that when the input unit is activated, the input communication device is able to transmit a signal to the control unit 200. As previously described, in some embodiments, the input pad 300 may also comprise an audio output 260 which is operatively coupled to the input communication unit 320 such that the control unit 200 may transmit a signal to the input pad activating the audio output 260.

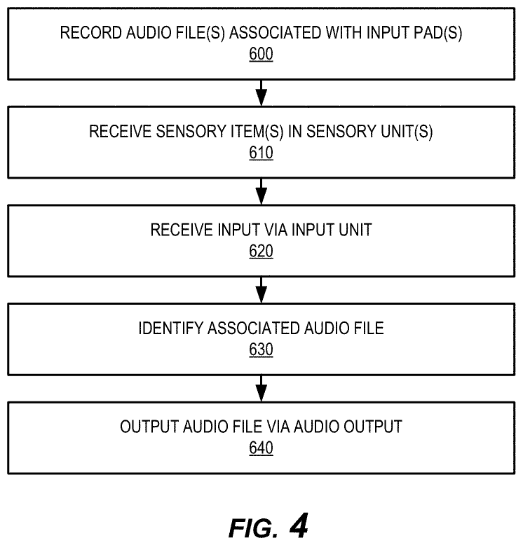

FIG. 4 is a high-level process flow illustrating a method of operation of the animal interaction device. The process begins in block 600, wherein for each one of the plurality of input pads 300, the command module 241 of the control unit 200 records an audio file via the audio input to be associated with a particular input pad. For example, one input pad may have an associated audio file which says the word “outside.” In some embodiments, this step may occur during the manufacturing process. The process continues in block 610, wherein a sensory item related to a particular audio file is inserted into the sensory unit 404 of the associated input pad. Continuing with the previous example, the sensory unit of the input pad associated with the audio file “outside” may contain grass, gravel, a picture of an outdoor area, the written word “outside,” and/or any combination of the like. In some embodiments, each sensory unit may be preloaded with a removable icon and/or word card during the manufacturing process. Additionally or alternatively, each sensory unit may be preloaded with a blank card. Any other set of commands may be used, including but not limited to, “play”, “go out”, “walk”, “food”, “water”, “nap”, “treat”, “hold”, etc.

The process continues in block 620, wherein an animal or human may activate an input unit 310 on one of the input pads by tapping or pressing. The activation of the input unit may trigger a signal to be transmitted to the control unit 200, which may utilize the command module 241 to identify the audio file associated with the activated input pad as shown in block 630. The process is complete in block 640, wherein the control unit may trigger the audio output 260, located on either the control unit or the input pad, to output the identified audio file.

As an animal is being trained to use a particular input pad, a human may press the particular input at the onset of a certain activity. For example, a human may press an input pad corresponding to the “outside” audio file each time the animal goes outside. This may allow the animal to associate the audio with the activity. To reinforce the association, the human may then take the animal outside every time the animal activates the “outside” audio file itself. In short, depending on the training method, the indicia on and/or the sensory items associated with input pads and the audio produced when the input pads are depressed are associated with certain commands and activities of the animal, as it interacts with humans. Through repetitive training, the animal can learn to communicate with humans via the device to thereby express its needs and desires.

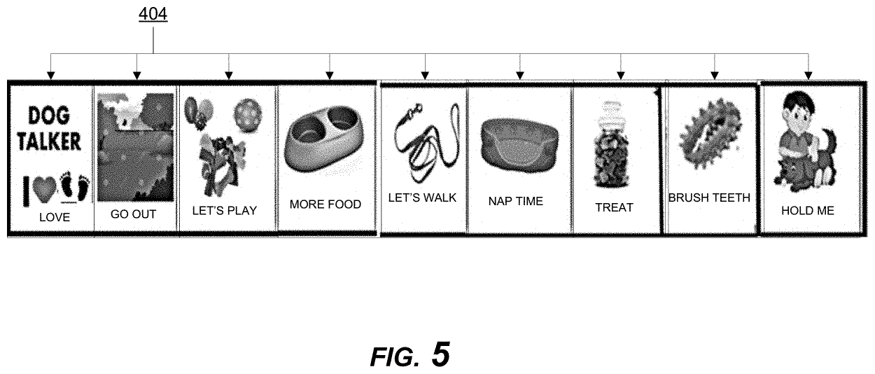

FIG. 5 illustrates an exemplary layout of sensory units 404, in accordance with some embodiments of the present invention. As discussed, the plurality of sensory units may be preloaded with icon cards during the manufacturing process, some examples of which are depicted in FIG. 5. In some embodiments, the positioning of different objects or actions on different input pads may be selected to avoid confusion. For example, the request for “go out” and “lets walk” may be located on input pads that are separated on the device so that the animal does not confuse the location of each when making a request. Further, commands or requests that sound similar phonetically may also be placed on input pads that are spaced apart on the device to avoid confusion.

The detachable nature of the input pads in some embodiments may allow a user to remove all but one input pad when first introducing an animal to the device. In this way, the user may add additional pads one at a time as the animal becomes familiar with each. In other embodiments, the input pads may not be detachable, and the user may choose to fill only one sensory unit at a time as the animal becomes familiar with each.

In some embodiments, the user may actively space apart certain activities along the set of input devices so to assist in training. For example, activities or commands that may get confused by the animal if located adjacent to each other on the device may be spaced apart to avoid such confusion. The user may also group various activities or commands together into logical section on the device. The user may essentially customize the input buttons as needed for the specific needs of the pet.

Referring back to FIG. 3A, the embodiment depicted therein includes audio input 250 and audio output 260 devices for providing audio outputs/queues based on the input pads depressed or otherwise selected. In some embodiment, the device may include a display for displaying video and/or image files as opposed to or in conjunction with the audio file. For example, the user may download to the memory device 240 one or more video or image files and associating the files with an input button pad 300. In this embodiment, when the input button pad 300 is depressed, the video or image file may be played by the processing device 230 on an optional display 270. In some embodiments, both an audio file and a video or image file may be associated with an input button pad, whereby when the button is depressed, the processing device controls both the audio output 260 and the display 270 to play both the audio and video or image files.

In the above embodiments, the communication device 220 and the input communication device 320 are described as “wired-type” communication devices. With reference to FIG. 3B, in some embodiments, one or more of the input button pads 300 may comprise an input communication device 320 that includes wireless electronics, such as a transmitter 330 for wireless communication with the communication device 220, which would also include at least a wireless receiver 280 for receiving wireless transmissions from the transmitter 330 of the input communication device 320. In some embodiments, the input communication device 320 of this embodiment may include its own power supply 340, processing device 350, memory device 360, and command module 370, whereby the input communication device 320 may be remotely located from the control unit 220 and communicate therewith via wireless communication. In this embodiment, the input communication device 320 may be located remotely at a convenient place of training the animal, while the outputs are transmitted wirelessly to the communication device 220. For example, in one embodiment, the system may include input pads 300 located at various locations in the environment, such as beside a back door, water dish, place where leashes are stored, and the like. In this way, the input pads are located at positions associated with the item they are associated with, such that the animal can go to those locations and press the input pad associated with the location.

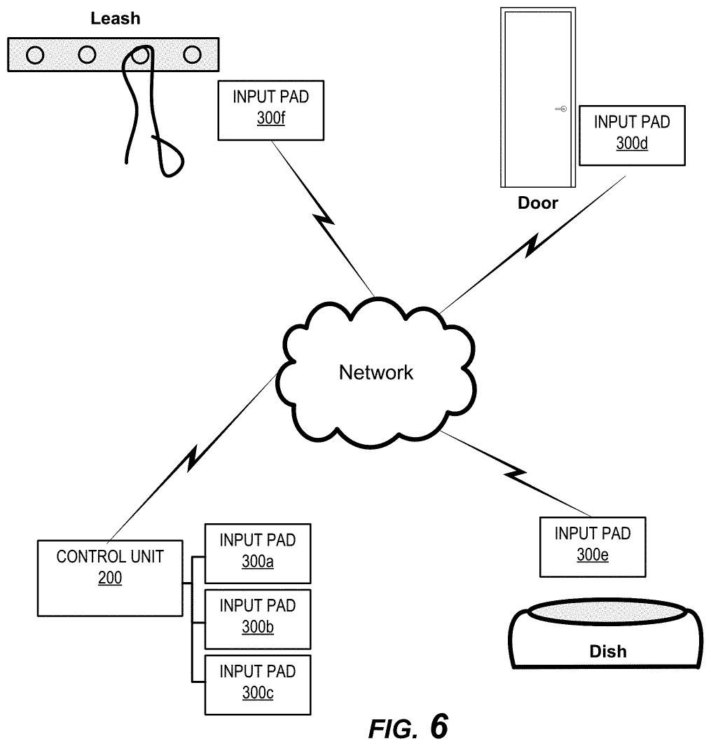

With reference to FIG. 6, an embodiment of the system is shown, where some input pads 300a thru 300c are connected via wired connection with the control unit 200. These input pads 300a thru 300c could represent sensory units, such as “Let's Play,” “Nap Time,” and the like. In addition, the system may also include wireless input pads 300d thru 300f that are located remotely from the control unit 200 and connect to the control unit 200 via a network 700 connection, such as WIFI, Bluetooth, Infrared, or the like. Each of the wireless input pads 300d thru 300f are associated with individual activities, such as near door 300d indicating “Go Out,” or near a dog dish 300e indicating “More Food,” or near a storage location of a leash 300f indicating “Let's Walk.” In this system, when the animal depresses one of the wireless input pads, such as 300d, the input pad transmits a signal wireless, via the network 700, to the control unit 200, whereby the control device plays an audio and/or video or image file associated with the input pad 300d to indicate the request by the animal.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined, or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system for facilitating animal-human interactions, said system comprising:
a flexible housing;
a control unit;
a memory device configured to store at least one audio file;
an audio output device;
a communication device; and
at least one input pad, wherein the input pad comprises:
an input unit, wherein the input unit is in operative communication with the communication device; and
a sensory unit, wherein the sensory unit is configured to hold at least one sensory object,
wherein said at least one input pad is associated with the at least one audio file stored in said memory device,
wherein the input unit is configured, such that when interacted with by an animal or human, said input unit transmits a detection signal to said control unit via said communication device, and
wherein said control unit, upon receiving a detection signal from the input unit, retrieves the audio file from memory associated with said at least one input pad and controls said audio output device to output audio from the audio file.

2. A system according to claim 1 further comprising a display connected to said control unit, wherein said memory device comprises at least one video or image file associated with the at least one input pad, wherein when said control unit receives a detection signal from said input pad, said control unit retrieves the audio or image file and controls said display to output the video or image from the audio or image file.

3. A system according to claim 1, wherein said at least one input pad further comprises a wireless transmitter for transmitting a detection signal wirelessly to said control unit via a wireless receiver in said communication device when said at least one input pad is interacted with by an animal or human.

4. A system according to claim 1, wherein said at least one input pad comprises:
a pad housing;
a padding layer; and
a communication layer,
wherein said sensory unit is connected to said pad housing.

5. A system according to claim 1, wherein said sensory unit comprises a pocket for receiving one or more sensory items.

6. A system according to claim 1 comprising a plurality of input pads, wherein at least one of said plurality of input pads is connected via wires to said communication device for communicating therewith, and wherein at least one of said plurality of input pads is configured for wireless connection with said communication device for communicating wirelessly therewith.

7. A system for facilitating animal-human interactions, said system comprising:
a housing;
a control unit;
a memory device configured to store a plurality of audio files;
an audio output device;
a communication device;
at least one wired input pad, wherein the wired input pad comprises:
a first input unit, wherein the first input unit is in operative communication with the communication device; and
a first sensory unit, wherein the sensory unit is configured to hold at least one sensory object,
wherein said at least one wired input pad is associated with at least one first audio file stored in said memory device,
wherein the first input unit is configured, such that when interacted with by an animal or human, said first input unit transmits a first detection signal to said control unit via said communication device;
at least one wireless input pad, wherein the wireless input pad comprises:
a second input unit;
a wireless transmitter configured for wireless communication with the communication device; and
a second sensory unit, wherein the sensory unit is configured to hold at least one sensory object,
wherein said at least one wireless input pad is associated with at least one second audio file stored in said memory device,
wherein the second input unit is configured, such that when interacted with by an animal or human, said second input unit transmits wirelessly a second detection signal to said control unit via said communication device, and
wherein said control unit, upon receiving either a first detection signal from the wired input unit or a second detection signal from the wireless input device, retrieves the respective first or second audio file from memory associated and controls said audio output device to output audio from the respective audio file.
